(19) United States
(12) Patent Application Publication
(10) Pub. No.: US 2022/0122593 A1
(43) Pub. Date: Apr. 21, 2022

(54) USER-FRIENDLY VIRTUAL VOICE ASSISTANT

(71) Applicant: Deutsche Telekom AG, Bonn (DE)

(72) Inventors: Jascha Minow, Bensheim (DE); Carl Jahn, Wiesbaden (DE); Said El Mallouki, St. Goar (DE); Martin Michael Platschek, Berlin (DE)

(21) Appl. No.: 17/504,553

(22) Filed: Oct. 19, 2021

(30) Foreign Application Priority Data
Oct. 21, 2020 (EP) 20 20 3064.9-1210

(51) Int. Cl. G10L 15/16; G10L 25/78; H04L 29/08; G06F 16/68

(52) U.S. Cl. CPC G10L 15/16; G10L 25/78; G10L 2015/088; G06F 16/686; H04L 67/12

(57) ABSTRACT

A method for activating a virtual voice assistant, which is in sleep mode, of a user terminal includes: recording a speech sequence of a user via a microphone of the user terminal; and implementing, by the user terminal, a first analysis as to whether the speech sequence is a voice command directed to the user terminal. Based on the first analysis revealing that the speech sequence is a voice command for the user terminal, the method further includes: implementing a second analysis of the speech sequence, wherein the second analysis determines the meaning of the voice command from the speech sequence; generating a voice response based on the voice command and outputting the voice response to the user via a speaker of the user terminal; and/or executing the voice command.

### CROSS-REFERENCE TO PRIOR APPLICATIONS

This application claims benefit to European Patent Application No. EP 20 20 3064.9-1210, filed on Oct. 21, 2020, which is hereby incorporated by reference herein.

### FIELD

The invention relates to a method, a communication system, a computer program product, and a user terminal that facilitates communication of a user with a virtual voice assistant at the user terminal.

### BACKGROUND

When communicating with a virtual voice assistant, such as “Alexa” or “Siri,” it is necessary to call a wake-up word, such as “Alexa” or “Hey, Siri,” so that the voice assistant in passive listening mode knows that the following command is directed at it and not at another person in the room. This is not a natural human communication, especially if there is no one else in the room.

The speed and authenticity of the voice control and interaction with a virtual voice assistant are thereby negatively affected and, moreover, the wake-up word requires a learning curve in humans, who must first learn the word and then pronounce it correctly; especially for older people, whom such a voice assistant can help particularly effectively, for example in emergency situations, it is difficult to become accustomed to using a wake-up word, or they may forget it in an urgent emergency situation. The use of different voice assistants at the same time is also therewith made difficult, since a user must always call the wake-up word required for the respective voice assistant. A further problem that has resulted in conjunction with the use of a plurality of voice assistants by a user is that each of these voice assistants has, or can execute, specific commands or specific “skills.” Although there may be many commands or skills that can be executed by all of these voice assistants, the specific commands can only be executed by the voice assistant provided for this purpose. Under certain circumstances, it may be even the same skill which is, however, “triggered” by different commands. In these instances, the user must know precisely which voice assistant must be addressed with which specific command. Given the many thousand skills available to the respective voice assistants, this of course does not work smoothly, so that frustration or malfunctions are inevitable.

In any event, the wake-up word thus interrupts at least the natural flow of speech, and thus has a disruptive effect. If the wake-up word is not recognized, the voice command given for the wake-up word and the wake-up word must be repeated again. This leads to frustration and an unnatural conversation with the voice assistant, and thus reduces acceptance and efficiency. Wake-up words are not part of the actual voice command.

The wake-up word may also be referred to as an activation word.

### SUMMARY

In an exemplary embodiment, the present invention provides a method for activating a virtual voice assistant, which is in sleep mode, of a user terminal. The method includes: recording a speech sequence of a user via a microphone of the user terminal; and implementing, by the user terminal, a first analysis as to whether the speech sequence is a voice command directed to the user terminal. Based on the first analysis revealing that the speech sequence is a voice command for the user terminal, the method further includes: implementing, by the user terminal or by a voice service platform in the backend to which the speech sequence was forwarded via a network, a second analysis of the speech sequence, wherein the second analysis determines the meaning of the voice command from the speech sequence; generating, by the user terminal or the voice service platform, a voice response, based on the voice command, and outputting the voice response to the user via a speaker of the user terminal; and/or executing, by the user terminal or the voice service platform, the voice command.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a diagram of a method according to the invention for activating a virtual voice assistant of a user terminal without using a “wake-up word.”

FIG. 2 shows a diagram of an association of voice commands with the virtual voice assistant from FIG. 1, provided for this purpose.

FIG. 3 shows an exemplary embodiment of how a machine learning algorithm can be trained with regard to detecting a voice command.

### DETAILED DESCRIPTION

Exemplary embodiments of the invention provide a method, a communication system, a computer program product, and a user terminal with a voice assistant, which facilitate the communication of people with the voice assistant.

The features of the various aspects of the invention described below, or of the various exemplary embodiments, can be combined with one another insofar as this is not explicitly ruled out or absolutely precluded from a technical standpoint.

To begin with, some terms will be explained:

Virtual voice assistant: A virtual assistant, also referred to as voice assistant or mobile assistant, is software that makes it possible to query information via communication in natural, human speech, to conduct dialogs, and to provide assistance services, in that it performs a speech analysis for speech recognition purposes, semantically interprets this, logically processes it, and finally formulates a response as a result via speech synthesis. Starting in about 2012, such applications got a wider distribution primarily on smartphones.

Sleep mode: The sleep state, also referred to as hibernation, and suspend to disk, together with the standby mode (suspend to RAM), constitutes two types of an energy-saving function of user terminals. They are used in particular in notebooks or smartphones, since there the saving of electrical energy when operating without a grid increases the battery life.

Activation hereinafter generally refers to the change from a sleep mode to a normal working mode of a user terminal.

In contrast to, for example, a coughing fit, a speech sequence refers to an intended articulation of a user.

According to a first aspect of the invention, a method for activating a virtual voice assistant, which is in sleep mode, of a user terminal is provided, wherein the method comprises the following steps:
recording a speech sequence of a user via a microphone unit of the user terminal. A recording mode of the microphone unit can thereby be operated actively and, in a sense, in the background at any time, so that everything a user says can be registered as a speech sequence;
Implementation of a first analysis, via an algorithm implemented at a computer unit of the user terminal, as to whether the speech sequence is a voice command directed to the user terminal and, if the analysis reveals that it is a voice command for the user terminal, implementing the following additional steps:
Implementation of a second analysis of the speech sequence by the user terminal and/or implementation of the second analysis of the speech sequence via a voice service platform in the backend to which the speech sequence was forwarded via a network, wherein the second analysis determines the meaning of the voice command from the speech sequence;
   Generation of a voice response based on the voice command by the user terminal or by the voice service platform, and outputting the voice response to the user via a speaker unit of the user terminal,
and/or
   Execution of the voice command by the user terminal or by the voice service platform, wherein the determined control command from the voice service platform to the user terminal if the second analysis has taken place at the voice service platform.

The user terminal may be, in particular, a smart speaker, a smartphone, a smartwatch, a television, or similar devices with a virtual voice assistant. In principle, the virtual voice assistant can be implemented at the user terminal or at the voice service platform. In the second instance, the user terminal serves in a sense as a conveyor of the voice command.

The method thus advantageously enables the functions of a virtual voice assistant to be used without needing to know a wake-up word, since the method makes it possible to conclude whether it is a voice command based solely on the speech sequence, wherein said voice command is then also executed. For example, this may be of great advantage if, in particular, older people fall and are only able to call “help.” The method can, in particular, also provide that the repeated calling of the word “help” is in any event detected as a voice command for the virtual assistant, wherein either the intelligent voice assistant or the voice service platform can automatically call an ambulance.

Resources are efficiently conserved, in that whether this is a voice command at all is first analyzed in the first analysis at the user terminal. On the one hand, the resources at the user terminal, since the second analysis only takes place if a voice command is present, and a conservation of resources with respect to the voice service platform. On the one hand, an unnecessary data transfer to the voice service platform and the second analysis by the voice service platform are performed only if it is actually a voice command. The first analysis preferably calculates a probability that is a voice command. If this probability exceeds a definable threshold, the second analysis is performed. By adjusting the threshold, it can be achieved that only “real” voice commands are provided for the second analysis.

There are voice commands for the virtual voice assistant given which it is advantageous not to first forward it to the voice service platform. For example, if the voice command relates to smart home services, such as switching on the washing machine, this can be triggered solely by the virtual voice assistant at the user terminal. However, if the virtual voice assistant is posed complex questions, it may be advantageous to resort to a large database of a voice service platform in order to evaluate these questions. If the voice commands relate to services from the Internet, such as a weather forecast, a corresponding response can be requested from the Internet both by the user terminal and by the voice service platform.

The generation of the voice response is advantageous for the user in particular when said user has posed a specific question to the virtual voice assistant. However, if the user has given, for example, a voice command which is to be executed by a smart home unit, a voice response does not necessarily need to be generated; rather, it may be sufficient to instruct the corresponding smart home unit with the command.

In order to recognize in the first analysis whether the command is a voice command, the method can use the following fact: If a user is in the room alone, it will usually be a voice command if the user speaks. In order to establish whether the person is in the room alone, the method can establish whether, during a predetermined time, for example during the last 5 minutes, a conversation has been conducted at all, or whether the received speech sequences originate from a single person only with regard to the audio signature. If the first analysis thus establishes that there has not been any conversation for more than 5 minutes, the speech sequence received after these 5 minutes is with high probability a voice command. For this analysis, the user terminal preferably has a memory which is configured to store an audio environment of the predetermined time and/or to store various speech profiles.

Preferably, additional recording of a camera image with a camera unit of the user terminal are taken, wherein this information of the camera image is used for the first analysis.

This has the advantage that whether the speech sequence is a voice command can be established with greater certainty via the first analysis. For example, if the user looks at the user terminal during the recording, this increases the probability that the user has just said a voice command. For this purpose, in particular a time stamp of the speech sequence can be compared with a time stamp of the camera image or of the video recordings of the camera image. The time stamps should hereby be matched in such a way that the camera image is synchronized to the speech sequence.

Advantageously, the first analysis analyzes a signal-to-noise ratio of the speech sequence.

This has the advantage that whether the speech sequence is a voice command can be established via the first analysis with greater certainty. The higher the signal-to-noise ratio, the greater the probability that the user is facing in the direction of the user terminal when saying the speech sequence. A further possibility is to compare the signal-to-noise ratio to previous signal-to-noise ratios in order to determine whether it is a voice command.

The first analysis preferably estimates a distance of the user via a distance measuring unit of the microphone unit.

This has the advantage that whether the speech sequence is a voice command can be established with greater certainty via the first analysis. If it is thereby determined, for example, that the user is no longer in the same room with the user terminal.

In a preferred embodiment, the second analysis includes a transcription of the speech sequence into text, wherein the voice command is determined from the transcribed text.

This has the advantage that the text can be analyzed more easily for certain keywords, such as commands. This additionally enables an analysis of the syntax or semantics in order to recognize the meaning of the statement as a voice command, and to recognize it as the “correct” voice command. In addition, the pure text form is “freed” of the characteristics of the user's pronunciation. This reduction in information makes the association with the correct voice command, for example based on a database or a trained model, easier and more efficient.

The second analysis is preferably executed by the algorithm implemented at the user terminal and/or by an algorithm implemented by a voice service platform.

This offers several advantages. For example, if the user terminal is already able to clearly recognize the voice command, both data transmission resources and voice service platform resources are hereby conserved. This variant is also advantageous with respect to aspects of data protection. However, if the algorithm implemented at the user terminal is not able to associate the correct voice command, because more modern and better resources, for example a larger database or a more modern algorithm, are available to the voice service platform, the second analysis can, in a sense, be quasi outsourced from the user terminal to the voice service platform.

Preferably, at least one of the two algorithms is an intelligent “machine learning algorithm” which is trained via monitored learning.

Especially if complex structures are to be classified into one of two classes, neural networks that characterize the machine learning algorithm are particularly effective and become increasingly better if these are trained with a sufficient set of training data whose class association is known, thus first class “Is-a-voice-command” and second class “Is-not-a-voice-command.” Monitored learning is a sub-field of machine learning. Learning thereby refers to the ability of an artificial intelligence to simulate principles. The results are known by natural laws or expert knowledge and are used to train the system. A learning algorithm attempts to find a hypothesis that makes predictions that are as unerring as possible. Hypothesis is thereby to be understood as a map that associates the suspected output value with each input value. The method thus conforms to a previously established output to be learned, the results of which are known. The results of the learning process can be compared to the known, correct results, i.e., “monitored.” By contrast, if the results are present in discrete form or if the values are qualitative, this is referred to as a classification problem.

Preferably, at least one of the algorithms is regularly updated. This has the advantage that the machine learning algorithm or the underlying model recognizes voice commands with increasingly greater reliability. By updating the algorithm at the user terminal, for example via the Internet, it can be achieved that both the first and the second analysis can be executed more efficiently and more unerringly by the user terminal. The second analysis may also be based on a machine learning algorithm which was trained in a monitored manner.

In a preferred embodiment, the voice command is analyzed by the voice service platform and is associated with a virtual voice assistant provided for the voice command from a plurality of voice assistants.

This has the advantage that the “correct” voice assistant can be found which is suitable for executing the voice command. This may be relevant if, for example, the user has several voice assistants, such as Alexa and Siri. These voice commands will not overlap, in part, so that a missing association could result in that a virtual voice assistant should execute a voice command that it cannot execute. Whether a voice assistant is intended for a specific voice command can also be determined, for example, based on the smart home functions associated with the virtual voice assistant. For example, if only Siri is linked to the “smart” washing machine, it is clear that a voice command such as “Start the washing machine” is unambiguously directed to this virtual voice assistant.

The voice service platform preferably transmits the voice command to the associated virtual voice assistant.

This offers the advantage that the correct virtual voice assistant can execute the commands, and the other virtual voice assistants do not receive data input with which they cannot do anything.

The correct association of the virtual assistant can be determined by comparing the voice command with a database stored in the voice service platform, and/or by a query to the plurality of voice assistants.

The first possibility offers an efficient variant to determine the correct virtual voice assistant without generating unnecessary data traffic. However, if no virtual voice assistant can be associated via the stored database, a query can be sent sequentially to all present voice assistants until the first confirms that it is suitable to execute the voice command. Sequential querying results in a desirable reduction in data traffic in the network.

According to a second aspect of the invention, a user terminal for activating a virtual voice assistant, which is in sleep mode, of the user terminal is provided, wherein the user terminal is configured to execute an embodiment of the method described above.

The advantages resulting herefrom are analogous to those described above.

According to a third aspect of the invention, a communication system comprising a user terminal and a voice service platform is provided, wherein the user terminal is connected to the voice service platform via a communication network, wherein the communication system is configured to activate a virtual voice assistant, which is in sleep mode, of the user terminal according to an embodiment of the method described above. Computing units, storage units are provided both at the user terminal and at the voice service platform in order to be able to execute method steps. In particular, corresponding algorithms are implemented at the computing units.

The advantages resulting herefrom are analogous to those described above.

According to a fourth aspect of the invention, a computer program product for activating a virtual voice assistant, which is in sleep mode, of the user terminal is provided,
wherein the computer program product induces execution of steps of a method at a user terminal according to an embodiment of the method described above
or
wherein the computer program product induces execution of steps of a method at a voice service platform according to an embodiment of the method described above.

The advantages resulting herefrom are analogous to those described above.

Exemplary embodiments of the present invention are explained below with reference to the accompanying Figures.

Numerous features of the present invention are explained in detail below based on exemplary embodiments. The present disclosure is not thereby limited to the specifically mentioned combinations of features. Rather, features mentioned here can be combined to form embodiments according to the invention insofar as this is not specifically ruled out below.

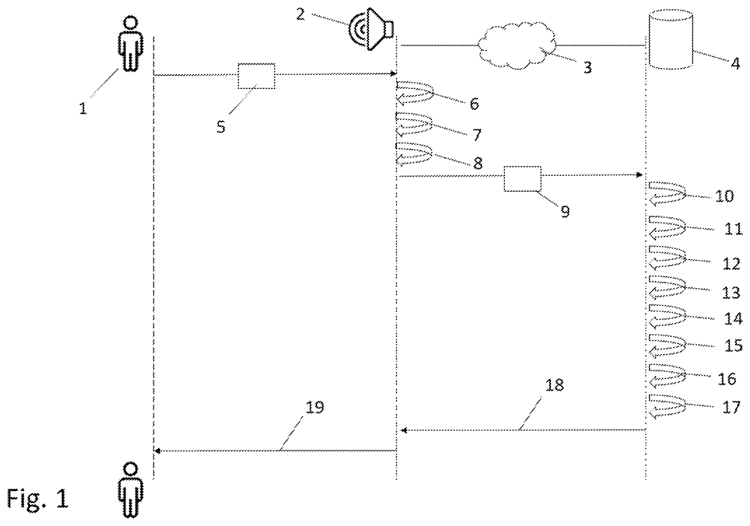

FIG. 1 shows a user 1 communicating with their user terminal 2, on which a virtual voice assistant is installed. The user terminal is connected to a voice service platform 4 via a network 3, in particular the Internet.

The method now proceeds as follows: The user speaks and hereby generates a speech sequence 5, wherein the speech sequence 5 can also be referred to as an audio signal 5. This speech sequence 5 is recorded by a microphone unit of the user terminal 2 as input. In particular, this speech sequence 5 includes no “wake-up word.” If the user terminal 2 is additionally equipped with a camera unit, the camera image is analyzed in step 6 as to whether the user, while saying the speech sequence 5, looks in the direction of the user terminal.

In step 7, the user terminal 2 calculates a signal-to-noise ratio of the speech sequence 5 and compares it with previous speech sequences as to whether the user was oriented in the direction of the user terminal 2 during the speech sequence 5.

In step 8, the probability that the speech sequence 5 of the user was a voice command 9 is determined by a first analysis. If this is so, the voice command 9 is transmitted via the network 3 to the voice service platform 4. In addition to the voice command 9, all additional sensor data, i.e., in particular audio data and camera data, of the user terminal 2 can also be transmitted to the voice service platform 4. Voice-ID technologies such as diarization can also be used to determine whether it is a voice command 9.

In step 10, a signal cone of the speech direction of the speech sequence 5 is determined by the speech service platform, based on the received sensor data, in order to be able to establish whether the speech sequence 5 is actually intended for the virtual voice assistant.

In step 11, using the speech sequence 5, an identification of the user 1 is performed and it is determined whether the speech sequence 5 can be associated with a known user or whether it originates from an unknown person.

In step 12 it is determined, based on the accentuation of the speech sequence 5, whether the voice command 9 is a question or an instruction by the user 1 to the virtual assistant.

In step 13, the speech sequence 5 is first transcribed into text and then analyzed in terms of semantics and syntax in order to associate a specific voice command with the speech sequence 5. A typical human syntax or semantics is hereby taken as a basis.

In step 14, the content of the voice command 9 is filtered as to whether the voice command 9 can be executed at all by the virtual assistant. A voice command 9, such as “Can you please get me a glass of water!”, cannot be executed by the virtual voice assistant.

The final determination of the probability that the speech sequence 5 was a voice command 9 for the virtual voice assistant follows in step 15.

In step 16, the following is executed: If the speech sequence 5 has been accepted as a voice command 9 for the virtual voice assistant, the resolution of domains, intentions, and entities takes place in order to execute the requested command.

In step 17, a voice response matching the voice command 9 is generated.

In step 18, the appropriate voice response is sent to the user terminal 2.

In step 19, speakers of the user terminal 2 play the appropriate voice response to the user 1.

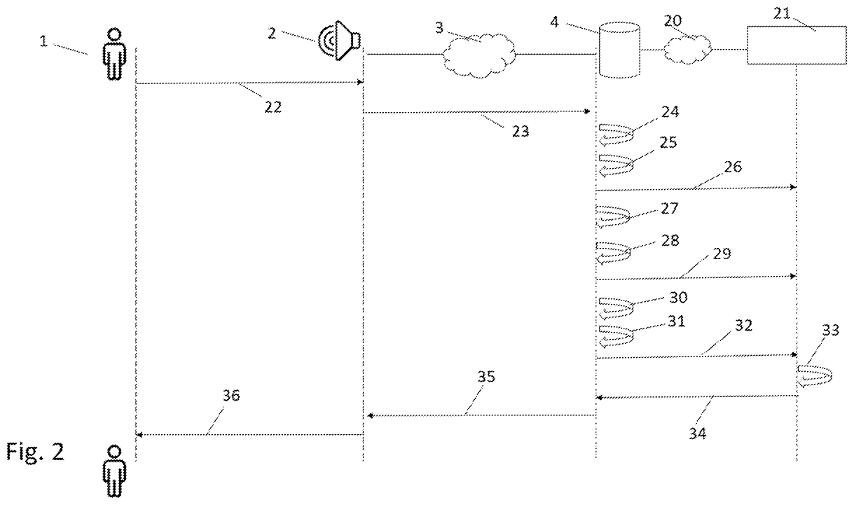

FIG. 2 shows a diagram of the association of voice commands with a virtual voice assistant from FIG. 1 that is provided for this purpose from a plurality of virtual voice assistants 21.

FIG. 2 includes steps for this purpose which can be combined with the steps of the exemplary embodiment from FIG. 1. In particular, an association of the corresponding virtual voice assistant 21 is only performed if it was first determined that the speech sequence 5 is a voice command.

FIG. 2 shows, in addition to FIG. 1, that the voice service platform 4 is connected to a plurality of virtual voice assistants 21 via a further network 20.

In step 22, the user 1 outputs the speech sequence 5 without hereby specifying a particular virtual voice assistant to be used for fulfilling the request. Moreover, the user also does not use a “wake-up word” in this instance.

In step 23, the speech sequence 5 is sent from the user terminal 2 to the voice service platform 4.

In step 24, the domain of the transcribed speech sequence 5 of the user 1 is resolved or determined as the next process.

In step 25, the corresponding virtual voice assistant is determined from the plurality of virtual voice assistants 21 based on the identified domain, which virtual voice assistant is to be used to fulfill the voice command 9 of the user 1 and which is capable of fulfilling the request.

In step 26, the voice command 9 is forwarded to the corresponding virtual voice assistant for processing if the domain is unique to the corresponding assistant.

Step 27: If the domain can be processed by multiple virtual voice assistants, further analyses of the voice command 9 are performed, for example the intent of the voice command, in order to be able to further limit a possible selection of the virtual voice assistants to a single virtual voice assistant, if possible

Step 28: The corresponding suitable virtual voice assistant is determined.

Step 29: The voice command 9 is forwarded to the determined virtual voice assistant, except if it was again not possible to uniquely determine the appropriate virtual voice assistant.

Step 30: In order to further limit the virtual voice assistants to a single virtual voice assistant, if possible, the context of the user as well as preferences or a command history are analyzed in order to determine which of the still remaining virtual voice assistants is either particularly suitable or can be uniquely determined for this task.

In step 31, the virtual voice assistant to be used is ultimately determined.

In step 32, the voice command 9 is forwarded to the determined virtual voice assistant.

In step 33, the virtual voice assistant generates the corresponding commands or the corresponding voice response based on the voice command 9.

In step 34, the voice response is sent to the voice service platform 4, wherein the voice service platform 4 transmits the voice response to the user terminal 2 in step 35.

In step 36, the user terminal 2 outputs the voice response to the user 1.

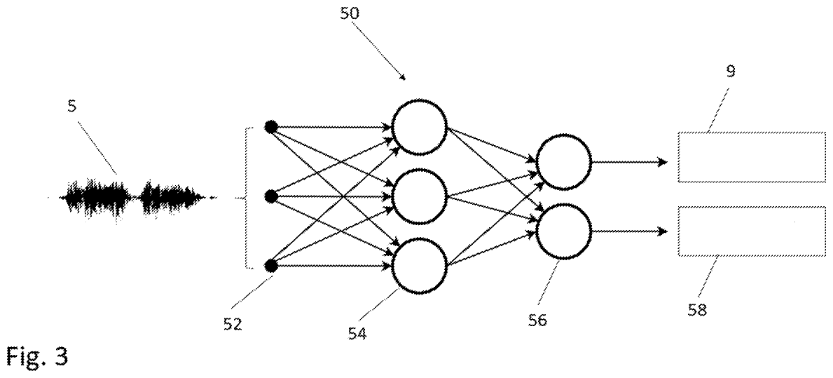

FIG. 3 shows an exemplary embodiment of how a machine learning algorithm can be trained with regard to detecting a voice command.

A neural network 50, which can be used in a sense as an algorithm for machine learning, has an input layer 52, wherein input data are made known to the neural network 50 via the input layer 52. Furthermore, the neural network 50 has one or preferably a plurality of internal layers 54, wherein connections between the nodes forming the individual layers are weighted during the training, depending on the intended application—the neural network 50 is hereby trained. Furthermore, the neural network 50 has an output layer 56.

If the neural network 50 is to be trained with respect to recognizing whether a speech sequence 5 forms a voice command 9, the speech frequency 5 can be passed on to the input layer 52. Thereafter, the neural network 50 will either output: “Is-a-voice-command” 9 or “Is-not-a-voice-command” 58.

Given monitored training, it is known beforehand whether the speech sequence 5 used as input is a voice command 9 or “Is-not-a-voice-command” 58.

The correct result is marked upon output. Via this feedback, the neural network 50 can learn in that it re-weights the connections between the nodes. The greater the number of speech sequences 5 that are selected, with which the neural network 50 is trained accordingly, the better that the machine learning algorithm can recognize whether the speech sequence 5 is a voice command 9 or not.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for activating a virtual voice assistant, which is in sleep mode, of a user terminal, wherein the method comprises:
recording a speech sequence of a user via a microphone of the user terminal;
implementing, by the user terminal, a first analysis as to whether the speech sequence is a voice command directed to the user terminal; and
based on the first analysis revealing that the speech sequence is a voice command for the user terminal:
implementing, by the user terminal or by a voice service platform in the backend to which the speech sequence was forwarded via a network, a second analysis of the speech sequence, wherein the second analysis determines the meaning of the voice command from the speech sequence;
generating, by the user terminal or the voice service platform, a voice response, based on the voice command, and outputting the voice response to the user via a speaker of the user terminal; and/or
executing, by the user terminal or the voice service platform, the voice command.

2. The method according to claim 1, further comprising:
recording, with a camera of the user terminal, a camera image, wherein information of the camera image is used for the first analysis.

3. The method according to claim 1, wherein the first analysis analyzes a signal-to-noise ratio of the speech sequence.

4. The method according to claim 1, wherein the first analysis estimates a distance of the user via a distance measuring unit of the microphone.

5. The method according to claim 1, wherein the second analysis comprises transcription of the speech sequence into text.

6. The method according to claim 5, wherein the voice command is determined from the transcribed text.

7. The method according to claim 1, wherein the second analysis is executed by the user terminal and/or by a voice service platform.

8. The method according to claim 1, wherein the first analysis and/or the second analysis utilizes a machine learning algorithm trained via monitored learning.

9. The method according to claim 8, wherein the machine learning algorithm is regularly updated.

10. The method according to claim 6, wherein the voice command is analyzed by the voice service platform and is associated with a virtual voice assistant, provided for the voice command, from a plurality of virtual voice assistants.

11. The method according to claim 10, wherein the voice service platform transmits the voice command to the associated virtual voice assistant.

12. The method according to claim 10, wherein the association is determined by comparing the voice command with a database stored at the voice service platform, and/or by a sequential query to the plurality of voice assistants.

13. (canceled)

14. A communication system, comprising:
a user terminal; and
a voice service platform;
wherein the user terminal is connected to the voice service platform via a communication network;
wherein the user terminal is configured to record a speech sequence of a user via a microphone of the user terminal;
wherein the user terminal is configured to implement a first analysis as to whether the speech sequence is a voice command directed to the user terminal; and
wherein:
the user terminal or a voice service platform in the backend to which the speech sequence was forwarded via a network is configured to implement, based on the first analysis revealing that the speech sequence is a voice command for the user terminal, a second analysis of the speech sequence, wherein the second analysis determines the meaning of the voice command from the speech sequence;
the user terminal or the voice service platform is configured to generate, based on the first analysis revealing that the speech sequence is a voice command for the user terminal, a voice response, based on the voice command, and the user terminal is configured to output the voice response to the user via a speaker of the user terminal; and/or
the user terminal or the voice service platform is configured to execute, based on the first analysis revealing that the speech sequence is a voice command for the user terminal, the voice command.

15. One or more non-transitory computer-readable mediums having processor-executable instructions thereon for activating a virtual voice assistant, which is in sleep mode, of a user terminal, wherein the processor-executable instructions, when executed, facilitate:
recording a speech sequence of a user via a microphone of the user terminal;
implementing, by the user terminal, a first analysis as to whether the speech sequence is a voice command directed to the user terminal; and
based on the first analysis revealing that the speech sequence is a voice command for the user terminal:
implementing, by the user terminal or by a voice service platform in the backend to which the speech sequence was forwarded via a network, a second analysis of the speech sequence, wherein the second analysis determines the meaning of the voice command from the speech sequence;
generating, by the user terminal or the voice service platform, a voice response, based on the voice command, and outputting the voice response to the user via a speaker of the user terminal; and/or
executing, by the user terminal or the voice service platform, the voice command.
